(19) United States
(12) Patent Application Publication
(10) Pub. No.: US 2015/0322305 A1
(43) Pub. Date: Nov. 12, 2015

(54) AUTO-ADHESIVE ELASTOMER COMPOSITION

(71) Applicant: HERAKLES, Les Cinq Chemins, Le Haillan (FR)

(72) Inventors: Christine GARCIA, Le Haillan (FR); Agnès AYMONIER, Begles (FR); Jacques REY, Merignac (FR); Gérald ROUSSEAU, Toulouse (FR); Alain SOUM, Gradignan (FR)

(21) Appl. No.: 14/655,587

(22) PCT Filed: Dec. 23, 2013
(86) PCT No.: PCT/FR2013/053251

§ 371 Date: Jun. 25, 2015

(30) Foreign Application Priority Data
Dec. 26, 2012 (FR) 12/03594

(51) Int. Cl. C09J 147/00; C08K 5/00; C08K 3/00

(52) U.S. Cl. CPC C09J 147/00; C08K 3/0033; C08K 5/0008

(57) ABSTRACT

A crosslinkable elastomer composition includes a mixture (a) of an elastomer composition based on an ethylene-propylene-diene terpolymer elastomer and (b) between 2 and 14 wt. %, in relation to the total weight of the composition, of an amphiphilic statistical or block copolymer of a saturated or unsaturated hydrocarbonated C₂-C₄ polymer functionalized by a polar functional group including a maleic anhydride group.

The present invention relates to the spontaneous adhesion of a thermal protection made of crosslinked elastomer with a composite material.

At the current time, an adhesion primer is required in order to perform this assembly. As it happens, like numerous adhesion primers, the adhesion primer used for this assembly:
a. consists to a large extent of solvents, with the presence in particular of solvents which pose H&S problems following the setting up of the REACH regulations and thus lead to a potential risk in terms of continuity owing to the harmful nature thereof;
b. requires prior curing before the composite substrate is brought alongside;
c. has no identified replacement.

In order to dispense with these limitations and to promote the bonding capacity of the crosslinked elastomer on the composite without recourse to adhesion primers, the inventors have discovered that it is possible to functionalize the surface of the crosslinked elastomer so as to make it self-adhesive to a composite material. This functionalization consists in modifying the elastomer composition by introducing amphiphilic molecules capable of establishing, by migration from the body to the surface, during the crosslinking of the elastomer composition, physicochemical and/or chemical connections between the crosslinked elastomer composition and the composite.

This concept, makes it possible, in addition to lifting the H&S risks, to reduce costs (elimination of the step of coating and curing of the adhesion primer) and to make the assembly reliable.

The present invention therefore relates to a crosslinkable elastomer composition comprising a mixture
(a) of an elastomer composition based on an ethylene-propylene-diene terpolymer elastomer and
(b) between 2% and 14% by weight, relative to the total weight of the composition, of a random or block amphiphilic copolymer of a saturated or unsaturated hydrocarbon-based C₂-C₄ polymer functionalized with a polar functional group comprising a maleic anhydride group.

The ethylene-propylene-diene terpolymer elastomer (a) according to the present invention, referred to as EPDM in the rest of the application, is an elastomer well known to those skilled in the art. This amorphous terpolymer is obtained by copolymerizing, in variable proportions, ethylene and propylene with a small amount of diene. The polymerization uses only one double bond of the diene. The second, lateral to the molecular chain, makes the elastomer crosslinkable, for example by conventional crosslinking with sulfur or with peroxides.

Advantageously, the EPDM (a) according to the present invention comprises, relative to the total weight of the terpolymer, between 60% and 85% by weight of ethylene, even more advantageously between 60% and 80% by weight, and between 2% and 12% by weight of the diene, advantageously between 2.5% and 12% by weight, the rest consisting of the propylene. The proportion of each of the monomers acts on the properties of the EPDM.

In one advantageous embodiment, the diene is not conjugated so as to avoid side reactions or gel formation. Advantageously, it is chosen from dicyclopentadiene, ethylidene norbornene and vinyl norbornene. Even more advantageously, it is ethylidene norbornene. The EPDM is commercially available, for example from the company Exxon Mobil Chemical.

For the purposes of the present invention, the term “amphiphilic copolymer” is intended to mean a copolymer which has both a polar part and a nonpolar part. The nonpolar part allows it to be chemically and/or physically compatible with the EPDM elastomer (a). The polar part comprises polar functional chemical groups comprising a maleic anhydride group which are capable of chemically and/or physically interacting with the resin of the composite that will be brought into contact with the crosslinked elastomer composition according to the present invention, so as to ensure self-adhesion through the creation of bonds, preferably covalent chemical bonds.

The amphiphilic copolymer (b) according to the invention must in addition have sufficient mobility so as to be able to migrate from the body to the surface of the elastomer composition according to the present invention during crosslinking thereof. For this, the copolymer chains must have a molar mass which has the best compromise between migration of the (polar) functional groups of the copolymer to the surface of the elastomer composition, and entanglement or even reaction of the nonpolar part of the copolymer with the elastomer composition, during the crosslinking of the elastomer composition according to the present invention.

It must also be stable at the temperature of crosslinking of the elastomer composition and of the composite according to the present invention, i.e. generally at a temperature of between 110 and 160° C. and advantageously for a period of between 60 and 300 minutes. The term “stability at the temperature of crosslinking” is intended to mean, for the purposes of the present invention, the maintaining of the presence of the maleic anhydride chemical groups capable of reacting with the composite resin after a cycle of between 60 and 300 min at the temperature of crosslinking of between 110° C. and 160° C. and the maintaining of the weight of the copolymer (advantageously its weight loss is less than 5% relative to the total weight of the copolymer (b) during this cycle).

In order to ensure the incorporation of the copolymer into the mixtures during the production of the elastomer composition according to the present invention, the copolymer (b) according to the present invention must have a io glass transition temperature below the composition mixing temperature;

likewise, in the case of a copolymer which has a crystalline phase, its melting point must be as close as possible to the mixing temperature, advantageously between 40 and 60° C., and more advantageously it is 50° C.

Under these conditions, the mobility of the copolymer is promoted during the increase in temperature until the crosslinking of the elastomer composition according to the present invention.

Thus, the amphiphilic copolymer added to the elastomer composition must (cf. FIG. 3):
have a double polarity (polar and nonpolar [P,N]) which is chemically or physically compatible with the (polar) resin and the (nonpolar) elastomer (FIG. 3a),
be chemically stable and migrate from the body to the surface, during the crosslinking step so as to bring to the surface the (polar) species which are reactive with respect to the resin (FIG. 3b),
establish the physical or chemical bonds with the resin of the composite during the winding (FIG. 3c),
generate phenomena of interdiffusion of the elastomer/composite chains promoting adhesion (FIG. 3d).

The amphiphilic copolymer (b) according to the invention may be a random or block polymer, i.e. the distribution of the polar (P) and nonpolar (N) functions may be:
either random (NNPPPNNPNPPNPNNN . . . )
or in blocks (diblocks: . . . NNN-PPP . . . ).

In the amphiphilic copolymer (b) according to the present invention, the saturated or unsaturated hydrocarbon-based C₂-C₄ polymer serves as a nonpolar backbone compatible with the elastomer (a).

For the purposes of the present invention, the term “saturated or unsaturated hydrocarbon-based C₂-C₄ polymer” is intended to mean any hydrocarbon-based polymer or copolymer comprising a linear or branched, advantageously linear, alkyl, alkenyl or alkynyl group comprising from 2 to 4 carbon atoms. It may thus be a C₂-C₄ polyolefin or a C₂-C₄ polyalkenylene.

Advantageously, the saturated or unsaturated hydrocarbon-based C₂-C₄ polymer is chosen from polyethylene, polyethylene-polypropylene (PE-PP) and polybutadiene.

For the purposes of the present invention, the expression “amphiphilic copolymer functionalized with a polar functional group comprising a maleic anhydride group” is intended to mean any copolymer obtained by functionalization or grafting of a polar function comprising a maleic anhydride group. The copolymer thus advantageously has the following formula (I):

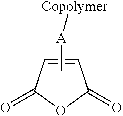

in which A represents a bond or a part of the functional group. Advantageously, it is a copolymer obtained by grafting of a polar functional group comprising a maleic anhydride group, i.e. advantageously by reaction between the hydrocarbon-based polymer and the functional group comprising maleic anhydride.

Advantageously, the polar functional group of the amphiphilic copolymer (b) is maleic anhydride. In this case, the phrase used is amphiphilic copolymer functionalized with a maleic anhydride group and advantageously A represents a bond. It is in particular a copolymer grafted with a maleic anhydride, i.e. advantageously by reaction between the hydrocarbon-based polymer and the maleic anhydride. Such copolymers are well known to those skilled in the art and are, for example, described in patent U.S. Pat. No. 5,300,569. They are also commercially available, for example from the company Cray Valley under the name Ricon® 130 MA, in particular Ricon® 130 MA8 or Ricon 131 MA20 or else from the company Aldrich under number 456632. The maleic anhydride content of the copolymer according to the present invention is very variable and it is in particular between 2% and 40% by weight, advantageously between 2% and 20% by weight, in particular between 2% and 10% by weight, relative to the total weight of the copolymer. Indeed, above 40% by weight, advantageously above 20% by weight, there is a risk of thermal instability of the copolymer.

In one particular embodiment of the invention, the crosslinkable elastomer composition according to the present invention comprises, relative to the total weight of the composition, between 2% and 10%, in particular between 3% and 10%, advantageously approximately 5% by weight. Indeed, sufficient copolymer is necessary in order for there to be a sufficient number of polar functional groups at the surface of the crosslinked elastomer composition for them to be able to react with the resin of the composite materials. The inventors have also noticed that the greater the amount of copolymer, the more the mechanical properties of the crosslinked composition decrease, in particular its tensile strength. Thus, for a content greater than 14% by weight, the tensile strength becomes too poor to be usable on a structure made of composite material, for example as thermal protection and/or internal sealing of a composite material and/or for accommodating the mechanical strains of this composite material.

In another embodiment of the invention, the crosslinkable elastomer composition according to the present invention comprises a filler, optionally a plasticizer, and a crosslinking system, advantageously consisting of peroxides. The filler makes it possible to reinforce the elastomer composition according to the present invention. It may be silica, carbon black or a combination thereof.

The plasticizer can improve the processing and the cold resistance of the elastomer composition according to the present invention. It may be aromatics or esters.

The crosslinking system makes it possible, during the crosslinking of the composition according to the present invention, to create a three-dimensional network by bridging of the chains of the EPDM elastomer (a), thereby providing the elastomer composition according to the present invention with mechanical strength. It may be sulfur or peroxides. Advantageously, it is peroxides.

The composition according to the present invention may also contain protective agents for protecting the elastomer composition according to the present invention against aging or against light. They may be amine derivatives or phenolic derivatives.

Finally, the elastomer composition according to the present invention may contain various other ingredients well known to those skilled in the art for specific applications or uses, such as tackifiying resins or flame retardants.

The present invention also relates to the process for preparing the crosslinkable elastomer composition according to the present invention, characterized in that it comprises the step of incorporating the amphiphilic copolymer (b) into the elastomer composition (a). The incorporating step is advantageously carried out at a temperature of between 40 and 60° C., in particular at 50° C.

Advantageously, the amphiphilic copolymer (b) is incorporated after incorporation of the other constituents of the elastomer composition according to the present invention, advantageously with an internal mixer or open mixer.

Advantageously, the incorporation is carried out using an open mixer.

The present invention further relates to a crosslinked elastomer composition, obtained by crosslinking, advantageously by means of peroxides, of the crosslinkable elastomer composition according to the present invention.

The present invention also relates to the process for producing the crosslinked elastomer composition according to the present invention, characterized in that it comprises the step of crosslinking the crosslinkable elastomer composition according to the present invention by means of a crosslinking system, advantageously at a temperature of between 110° C. and 160° C., even more advantageously under pressure and under vacuum. In one particular embodiment, the process according to the present invention comprises a step, prior to the crosslinking step, of bringing the elastomer composition according to the present invention into contact with polar or nonpolar, advantageously polar, processing films or fabrics. Advantageously, the steps of bringing processing films or fabrics into contact and of crosslinking are simultaneous.

Advantageously, the crosslinking step lasts between 60 and 300 minutes and takes place under vacuum and under pressure.

The present invention also relates to the use of the crosslinked elastomer composition according to the present invention as thermal protection and/or internal sealing of a composite material and/or for accommodating the mechanical strains of this composite material.

Thus, while adhering directly to the composite without recourse to the use of adhesion primer, the crosslinked elastomer composition according to the present invention can coat a composite material in order to protect it against high temperatures (by virtue of its low diffusivity and its resistance to erosion) and/or provide internal sealing of said composite and/or accommodate mechanical strains with good resistance to aging. The present invention further relates to an assembly comprising:
(A) a structure made of composite material,
(B) a coating layer made of crosslinked elastomer composition according to the present invention.

Advantageously, the thickness of this coating layer is at least 1 mm, in particular between 1 mm and 200 mm.

A composite material is composed of various phases called matrix and reinforcement. The composite material has properties that the elements alone do not possess. The matrix provides cohesion between the reinforcements in order to distribute the mechanical stresses. The reinforcements used provide the mechanical properties of the composites.

The composite materials provide better properties than a metal structure. They enable a gain in weight and they resist higher pressure for a smaller composite thickness.

Advantageously, the matrix of the composite material (A) is chosen from epoxy, phenolic or bismaleimide resins. Advantageously, it is epoxy resin. Even more advantageously, the resin is made of bisphenol A diglycidyl ether. Advantageously, the reinforcement is made of Kevlar fibers, glass fibers or carbon fibers, even more advantageously of carbon fibers since they have better mechanical strength.

Thus, advantageously, the matrix of the composite material (A) is an epoxy resin and the reinforcement is made of carbon fibers.

In one particular embodiment of the invention, the matrix of the composite material comprises, before crosslinking thereof, a crosslinking agent. Advantageously, this crosslinking agent consists, in the case of epoxy resins, of a polyamine monomer such as, for example, triethylenetetramine, an amide, cycloaliphatic crosslinking agents, imidazoles, polymercaptan agents, aromatic or aliphatic amines and also acid anhydrides. Advantageously, it is an aromatic amine, in particular diethyltoluenediamine (DETDA). The production of a structure made of composite materials is well known to those skilled in the art.

Thus, advantageously, the assembly according to the present invention does not comprise adhesive or adhesive primer between the structure made of composite material (A) and the coating layer of elastomer composition (B). Thus, the coating layer of a crosslinked elastomer composition according to the present invention can be directly applied to the structure made of composite material.

The present invention also relates to the process for producing the assembly according to the present invention, characterized in that it comprises the following successive steps:
a) preparing the crosslinkable elastomer composition according to the present invention, advantageously by means of the process according to the present invention;
b) crosslinking the elastomer composition according to the present invention obtained in step a), advantageously by means of the process according to the present invention;
c) bringing a composite material into contact with the crosslinked elastomer composition obtained in step b);
d) crosslinking the resin of the composite material by means of a suitable thermal cycle in order to enable spontaneous adhesion between the crosslinked elastomer composition and the resin of the composite material, advantageously at a temperature of between 70 and 130° C.

During the crosslinking of the resin of the composite material, the polar functional groups comprising a maleic anhydride group that are present at the surface of the crosslinked elastomer composition according to the present invention must interact with this resin, advantageously so as to form covalent bonds.

In particular when the resin is an epoxy resin, and the functional group is a maleic anhydride, the reaction takes place in two steps: first in an initiation step, the maleic anhydride group of the copolymer must react with an R1-OH group according to the following reaction:

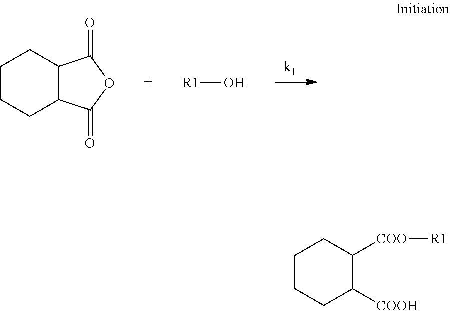

R1 represents a C₁-C₆ alkyl group or a hydrogen atom.

If no alcohol is used in the production of the composite, this initiation step takes place by virtue of the presence of water (moisture content of the medium).

There is then an esterification reaction between the maleic anhydride of the copolymer of which the chain has been opened and the epoxide of the resin, according to the following reaction scheme:

Esterification

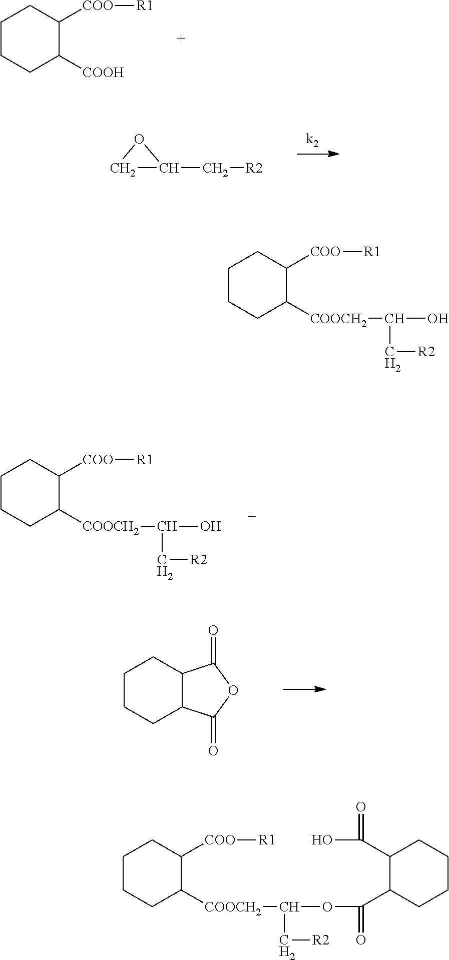

in which R2 represents the residue of the resin.

In the case where the resin is an epoxy resin, the suitable thermal cycle is advantageously between 6 and 30 hours at temperatures of between 70 and 130° C.

Finally, the present invention relates to the use of the assembly according to the present invention in the aeronautics or aerospace fields, advantageously in propulsion systems.

The invention will be understood more clearly in the light of figures and examples which follow.

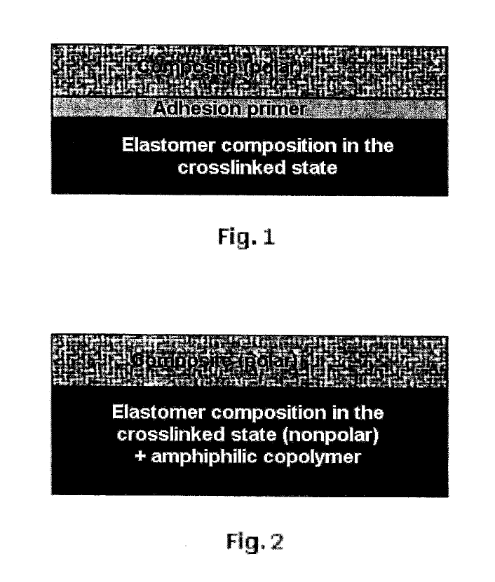

FIG. 1 represents the current system of bonding with an adhesion primer between an epoxy resin and a crosslinked thermal protection elastomer.

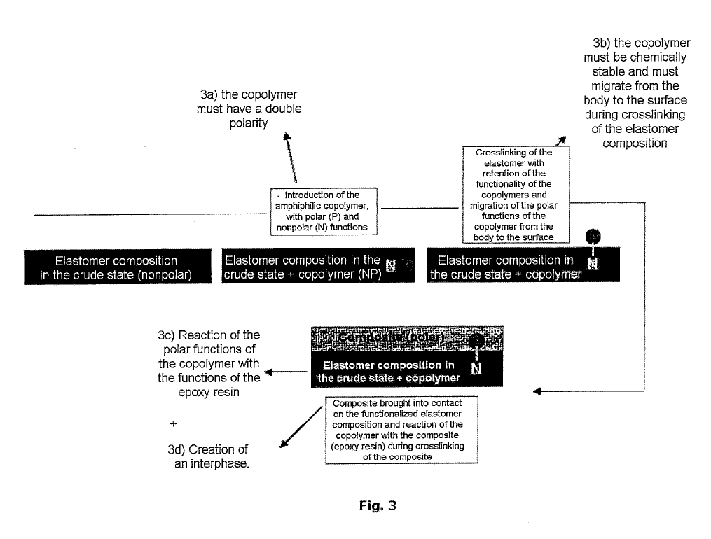

FIG. 2 represents the final assembly between (A) and (B) according to the present invention.

FIG. 3 represents the diagram of the process for producing the final assembly between (A) and (B) according to the present invention.

### EXAMPLE 1

### Selection of the Copolymers Before Incorporation Into the Elastomer Composition

The various copolymers tested are grouped together in table 1 below:

TABLE 1
List of copolymers tested

| | | | Possibility of | Possibility of | |
|---|---|---|---|---|---|
| | Possibility of | Possibility of | physical | chemical | |
| | physical | chemical | interaction | interaction | |
| | interactions | interactions | with the | with the | Elastomer |
| Characteristic | with the resin | with the resin | elastomer | elastomer | compatibility |
| Polybutadiene/ | Yes | Yes | Yes | Yes | Yes |
| maleic anhydride | | | | | |
| (8%) (Ricon ® | | | | | |
| 130 MA8 from | | | | | |
| Cray Valley) | | | | | |
| Polybutadiene/ | Yes | Yes | Yes | Yes | Yes |
| maleic anhydride | | | | | |
| (20%) (Ricon ® | | | | | |
| 131 MA20 from | | | | | |
| Cray Valley) | | | | | |
| Polyethylene/ | Yes | Yes | Yes | No | Yes |
| maleic anhydride | | | | | |
| (3-3.5%) (456632 | | | | | |
| from Aldrich) | | | | | |
| Polyethylene/ | Yes | No | Yes | No | Yes |
| polyethylene oxide | | | | | |
| (50%) (458961 | | | | | |
| from Aldrich) | | | | | |

All the copolymers are random copolymers except the polyethylene/polyethylene oxide (PE/PEO) which is a block copolymer. Before selecting the copolymers for producing the formulations, a study of the copolymers alone was carried out in order to study their thermal behavior. It is in fact necessary for the copolymers selected to be stable between 110° C. and 160° C., which is the temperature of crosslinking of the EPDM elastomer (a) and of the composite used in the context of the examples.

All the copolymers have the same characteristics:
a glass transition temperature (Tg) below 20° C. The processing thereof will therefore be facilitated in the mixtures during the production and they will gain mobility during the increase in temperature until crosslinking;
thermal stability at 160° C.: they lose, on average, less than 2% of their weight. This weight loss is attributed to the presence of moisture;
the desired polar functional groups are still present after 100 min at 160° C.

### EXAMPLE 2

### Evaluation of the Copolymers Used for the Preparation of Crosslinked Elastomer Compositions According to the present invention

The copolymers selected in example 1 were incorporated into an elastomer composition in a content of between 5% and 14% by weight relative to the total weight of the elastomer composition according to the invention, in order to verify the influence of the amount of copolymer.

The process for producing the elastomer composition was carried out by means of an open mixer and each copolymer was introduced into the elastomer composition according to the invention in a content of from 5% to 14% by weight. The mixtures prepared are grouped together in table 2 below:

TABLE 2
List of mixtures prepared

| | Theoretical % by | |
|---|---|---|
| | weight in the | |
| Product incorporated | mixture | Example |
| None (control) | 0 | Comparative 1 (C1) |
| Polybutadiene/maleic | 5 | Example 1 |
| anhydride (8%) | | |
| Polybutadiene/maleic | 10 | Example 2 |
| anhydride (8%) | | |
| Polybutadiene/maleic | 5 | Example 3 |
| anhydride (20%) | | |
| Polyethylene/maleic | 5 | Example 4 |
| anhydride (3-3.5%) | | |
| Polyethylene/maleic | 10 | Example 5 |
| anhydride (3-3.5%) | | |
| Polybutadiene/maleic | 10 | Example 6 |
| anhydride (20%) | | |
| Polyethylene/polyethylene | 5 | Comparative 2 (C2) |
| oxide (50%) | | |
| Polyethylene/polyethylene | 10 | Comparative 3 (C3) |
| oxide (50%) | | |
| Polyethylene/polyethylene | 14 | Comparative 4 (C4) |
| oxide (50%) | | |

These elastomer mixtures are then prepared with the various processing films and fabrics for crosslinking under pressure and under vacuum according to the cycle 100 minutes at 160° C.

In order to summarily evaluate the surface and volume properties of these new formulations, the following characterizations were carried out:

Surface Characterization
Infrared analyses (ATR-FTIR) before curing the elastomer (verification of the stability of the functions after mixing) and after curing at 160° C. for 100 minutes (in order to evaluate whether, at the surface, the reactive functions have migrated in order to be able to react with the epoxy functions of the resin). The spectrum transmission window was 4000 to 500 cm⁻¹.
Surface energy measurements according to the sessile drop method (simple method which makes it possible to determine the capacity of a material to be wetted by a liquid). A high surface energy is a condition that is required (but not sufficient) for performing good bonding. It is necessary for the energy of the surface to be bonded to be at least equivalent to that of the adhesion primer. In our case, in order to ensure self-adhesion between the elastomer and the composite, the objective to be achieved is an increase in the surface energy of the elastomer composition of the present invention compared with the elastomer composition without copolymer.

Characterization of the Volume:
Rheometric test according to standard NF T43015 at 160° C. for 100 min for each mixture in the crude state in order to evaluate the impact of the addition of the copolymer on the crosslinking kinetics of the material.
Unidirectional tensile test according to standard NF ISO 37 on each mixture in the crosslinked state in order to evaluate the impact of the copolymer on the mechanical properties of the elastomer composition. The tensile strength, the maximum elongation at break, and the stresses for 50%, 100%, 200% and 300% elongation are in particular evaluated and are compared with the characteristics of the crosslinked elastomer compositions without copolymer (control C1).

At the end of this basic characterization, the mixtures are retained for example 3 (with at least 2 different copolymers) on the basis of the following criteria in order of priority:
Surface energy as high as possible and/or having a strong polar contribution (which is assumed to be favorable with respect to the polar resin), confirming the presence of “polar” chemical functions.
Mechanical and rheometric properties as close as possible to those of the elastomer composition without amphiphilic copolymer.

TABLE 3
Results of the mechanical tests on the vulcanized elastomer
compositions

| | Example | | | | | | |
|---|---|---|---|---|---|---|---|
| | C1 | Ex 1 | Ex 2 | Ex 3 | C2 | C3 | C4 |
| Tensile strength (MPa) | 1 | 0.7 | 0.7 | 0.8 | 0.95 | 0.8 | 0.5 |
| Elongation at break (%) | 1 | 1.07 | 1.39 | 1.13 | 1.28 | 1.50 | 1.58 |
| Stress at 50% elongation | 1 | 0.89 | 0.78 | 0.92 | 0.86 | 0.78 | 0.82 |
| (MPa) | | | | | | | |

| | Example | | | | |
|---|---|---|---|---|---|
| | C9 | C10 | Ex 4 | Ex 5 | Ex 6 |
| Tensile strength (MPa) | 0.9 | 0.8 | 0.9 | 0.87 | 0.65 |
| Elongation at break (%) | 0.99 | 0.98 | 1.13 | 1.26 | 0.96 |
| Stress at 50% elongation | 1.07 | 1.07 | 0.96 | 1 | 1.21 |
| (MPa) | | | | | |

At the end of the various tests carried out, four elastomer compositions according to the present invention were selected with the following copolymers:
PE/PEO at 5% by weight (C2) for its mechanical properties close to the reference.
PE/PEO at 14% by weight (C4) for its total surface energy greater than 17% relative to the reference with a significant portion of polar part (+30% relative to the reference).
PE/maleic anhydride at 5% by weight (Ex 4) with good mechanical properties and with a surface energy greater than the reference with a polar part identical to this reference (+0.40%).
Polybutadiene/maleic anhydride (8%) at 5% by weight (Ex 1) with acceptable mechanical properties and an acceptable surface energy (increase in total energy of 23%).

The polybutadiene/maleic anhydride (20%) copolymer at 10% by weight (Ex 6) was not retained since it is not possible to remove the processing films and fabrics from this functionalized elastomer composition. These crosslinked elastomer compositions therefore appear to have a bonding power and therefore adhesive power greater than that of all the other crosslinked elastomer compositions.

### EXAMPLE 3

### Evaluation of the Elastomer/Composite Assembly

The assembly of the elastomer with the composite is carried out using the elastomer composite of the present invention (B) and the composite described in the present invention (A). The bonding between these two materials is tested with 90° peel test samples according to standard ISO 4578.

The vulcanized elastomer compositions were produced as indicated in example 2 with the copolymer in the required proportions (5% or 14% by weight relative to the total weight of the composition) according to the types of copolymers selected. Once the elastomer compositions have been crosslinked, they were brought into contact with an epoxy resin/carbon fiber preimpregnated composite. The assembly was then crosslinked for 22 hours between 70° C. and 90° C.

The results are grouped together in tables 4 and 5 below and compared to the results obtained with a reference composition obtained by bonding, with an adhesion primer, of the crosslinked elastomer compositions not containing copolymer.

TABLE 4
90° peel resistance results

| | | Peel resistance |
|---|---|---|
| | | normed with respect |
| Examples | Copolymer tested | to the reference |
| C1 | None: Reference elastomer | 1 |
| | composition + adhesion primer | |
| Ex 1 | Polybutadiene/maleic anhydride (8%) | 1 |
| | at 5% by weight: composite accord- | |
| | ing to the present invention | |
| C2 | PE/PEO at 5% by weight: | 0.17 |
| | comparative example | |
| C4 | PE/PEO at 14% by weight: | 0.07 |
| | comparative example | |
| Ex 4 | PE/maleic anhydride (3-3.5%) | 0.6 |
| | at 5% by weight: composite accord- | |
| | ing to the present invention | |

TABLE 5
90° peel rupture features

| | | Superficial | | |
|---|---|---|---|---|
| | | cohesive | | |
| | Cohesive | elastomer | Superficial cohesive | |
| | elastomer | composition/ | composite/elastomer | |
| Example | composition | composite | composition | Adhesive |
| C1 | 100% | 0% | 0% | 0% |
| Ex 1 | 88% | 12% | 0% | 0% |
| C2 | 0% | 0% | 0% | 100% |
| C4 | 0% | 0% | 0% | 100% |
| Ex 4 | 14% | 26% | 60% | 0% |

The results show that:
the test specimens prepared with the elastomer composition functionalized with the polybutadiene/maleic anhydride (8%) copolymer are advantageous in the context of the present invention since the peel values are equivalent to that of the reference compound with adhesion agent, and with predominantly cohesive features;
the test samples prepared with the elastomer composition functionalized with the PE/maleic anhydride (3-3.5%) copolymer exhibit good peel resistance (Rp) values with rather cohesive rupture features;
the test samples produced with the elastomer composition with the PE/PEO copolymer have low peel values and adhesive rupture features. These features reflect an absence of adhesion between the elastomer composition and the composite. This is not advantageous in the context of the present invention.

In the context of the present invention only the polybutadiene/maleic anhydride (8%) and PE/maleic anhydride (3-3.5%) copolymers are retained.

The reactive groups that are the most advantageous in the copolymers according to the present invention are therefore the maleic anhydride groups.

Thus, the information that can be deduced in the light of the examples is the following:
the surface migration is more easily demonstrated by measurement of the surface energy for the block copolymers than for the random copolymers (surface polar function density greater for the block copolymer than for random copolymers).
The copolymers have the capacity to modify the surface chemistry so as to make it self-adhesive.
The chemical functions and their interactions which may be chemical or physicochemical both with the elastomer matrix and with the resin of the composite play an important role in the self-adhesion process. Indeed, the chemical functions capable of reacting with the epoxy resin have the capacity to establish robust bonds (cohesive rupture features and higher values at rupture) contrary to the bonds created by the copolymers with physical interactions. The chemical functions which are the most advantageous are the maleic anhydride functions. Likewise, for reasons of compatibility with the EPDM elastomer, the nonpolar part of the copolymer should be a saturated or unsaturated hydrocarbon-based C₂-C₄ polymer and in particular polybutadiene or polyethylene.
A copolymer content of 5% by weight relative to the total weight of the composition appears to be the most advantageous for keeping good mechanical properties and thus avoiding excessive plasticizing of the crosslinked elastomer composition.

Thus, the copolymers that can be used in the context of the present invention are random or block amphiphilic copolymers of a polyalkylene of which the alkyl group is C₂-C₄ with a polyalkylene of which the alkyl group is C₂-C₄, functionalized with a polar functional group comprising a maleic anhydride group.

1. A crosslinkable elastomer composition comprising a mixture
(a) of an elastomer composition based on an ethylene-propylene-diene terpolymer elastomer and
(b) between 2% and 14% by weight, relative to the total weight of the composition, of a random or block amphiphilic copolymer of a saturated or unsaturated hydrocarbon-based C₂-C₄ polymer functionalized with a polar functional group comprising a maleic anhydride group.

2. The composition as claimed in claim 1, wherein the saturated or unsaturated hydrocarbon-based C₂-C₄ polymer is chosen from polyethylene, polyethylene-polypropylene and polybutadiene.

3. The composition as claimed in claim 1, wherein the terpolymer elastomer (a) comprises, relative to the total weight of the terpolymer, between 60% and 80% by weight of ethylene, between 2% and 12% by weight of the diene, the rest consisting of propylene.

4. The composition as claimed in claim 1, wherein the diene is ethylene norbornene.

5. The composition as claimed in claim 1, further comprising a filler, optionally a plasticizer, and a crosslinking system.

6. The composition as claimed in claim 1, comprising, relative to the total weight of the composition, between 3% and 10% by weight of the amphiphilic copolymer (b).

7. The composition as claimed in claim 1, wherein the polar functional group of the amphiphilic copolymer is maleic anhydride.

8. A process for preparing the crosslinkable elastomer composition as claimed in claim 1, comprising incorporating the amphiphilic copolymer (b) into the elastomer composition (a).

9. A crosslinked elastomer composition obtained by crosslinking the crosslinkable elastomer composition as claimed in claim 1.

10. A process for producing the crosslinked composition as claimed in claim 9, comprising crosslinking the crosslinkable elastomer composition by means of a crosslinking system.

11. The process as claimed in claim 10, comprising, prior to the crosslinking, bringing the crosslinkable elastomer composition into contact with polar or nonpolar, processing fabrics or films.

12. A composite material comprising as thermal protection and/or internal sealing and/or for accommodating mechanical strains of the composite material the crosslinked elastomer composition as claimed in claim 9.

13. An assembly comprising:
(A) a structure made of composite material, and
(B) a coating layer of crosslinked elastomer composition as claimed in claim 9.

14. The assembly as claimed in claim 13, wherein a matrix of the composite material (A) is made of epoxy resin, and reinforcements are made of carbon fiber.

15. The assembly as claimed in claim 13, wherein the assembly does not comprise adhesive or adhesive primer between the structure made of composite material (A) and the coating layer of crosslinked elastomer composition (B).

16. A process for producing the assembly as claimed in claim 13, comprising:
a) preparing the crosslinkable elastomer composition;
b) crosslinking the crosslinkable elastomer composition obtained in step a);
c) bringing a composite material in a non-crosslinked state into contact with the crosslinked elastomer composition obtained in step b);
d) crosslinking a resin of the composite material by means of a suitable thermal cycle in order to allow spontaneous adhesion between the crosslinked elastomer composition and the resin of the composite material.

17. A propulsion system comprising the assembly as claimed in claim 13.

18. The composition as claimed in claim 1, wherein the saturated or unsaturated hydrocarbons based C₂-C₄ polymer is polybutadiene.

19. The composition as claimed in claim 6, comprising, relative to the total weight of the composition, 5% by weight of the amphiphilic copolymer (b).
